(19) United States
(12) Patent Application Publication
(10) Pub. No.: US 2004/0262352 A1
(43) Pub. Date: Dec. 30, 2004

(54) [VEHICLE CONSOLE WITH ACCORDION-STYLE MEDIA STORAGE]

(75) Inventors: Alan Sturt, West Bloomfield, MI (US); James A Mulvihill, Royal Oak, MI (US)

Correspondence Address: BIR LAW, PLC, 45094 MIDDLEBURY CT., CANTON, MI, 48188-3215, US

(73) Assignee: LEAR CORPORATION, Southfield, MI (US)

(21) Appl. No.: 10/604,038

(22) Filed: Jun. 24, 2003

(51) Int. Cl. B60R 11/00; B60R 9/00; B60R 7/00

(52) U.S. Cl. 224/542; 224/311

(57) ABSTRACT

A vehicle console includes a media storage compartment having a plurality of receptacles arranged to selectively fan-out to facilitate access to the receptacles for storage and retrieval of items. The vehicle console may be an overhead console, a center console attached to the floor or a seat, or integrated into another portion of the interior such as a door panel or dashboard, for example. In one embodiment, a plurality of receptacles joined together with collapsible and expandable spacing therebetween facilitates storage and retrieval of items upon opening of a storage compartment door. The receptacles may be implemented by plastic sleeves flexibly connected by a string, band, webbing, or other material to fan-out, accordion style, and present the stowed items to a user upon opening of the storage compartment door, while collapsing within the storage compartment upon closing of the door for efficient storage.

### BACKGROUND OF INVENTION

1. Field of the Invention

The present invention relates to a system and method for storing items in a vehicle console.

2. Background Art

As travelers and commuters spend an increasing amount of time in various types of vehicles, such as automobiles, trucks, buses, airplanes, watercraft, trains, and the like, more comfort, convenience, and entertainment systems are becoming standard or optionally available equipment. With the evolution of audio and video technology from primarily analog equipment to primarily digital equipment, audio and video storage media have changed from 8-track, cassette, and videotape to CD's, DVD's, floppy discs, and solid-state memory cards. While most vehicles include a variety of general-purpose storage areas, the use of these areas to stow digital media is often inconvenient and undesirable. Loose items may damage digital storage media, items or media may rattle or fall out of a storage compartment during transit, or items and/or media may simply be unorganized with the ensuing difficulty in locating a desired item.

### SUMMARY OF INVENTION

The present invention includes a vehicle console having a media storage compartment with a plurality of receptacles arranged to selectively fan-out to facilitate access to the receptacles for storage and retrieval of items. The vehicle console may be an overhead console attached to an interior roof of the vehicle, a center console attached to the interior floor or a seat of the vehicle, or integrated into another portion of the vehicle interior such as the door or dashboard, for example.

In one embodiment, the invention includes a plurality of receptacles joined together with collapsible and expandable spacing therebetween to facilitate storage and retrieval of items upon opening of a storage compartment door. The receptacles may be implemented by plastic sleeves flexibly connected by a string, webbing, or other material to fan-out and present the stowed items to a user upon opening of the storage compartment door, while collapsing within the storage compartment upon closing of the door for efficient storage. The sleeves or receptacles may include an arcuate recessed portion at the edge to facilitate grasping of flat media, such as CD's, DVD's, or memory cards, for example. The sleeves may be laterally accessible from either or both sides so stored items can hang from an overhead console without falling out of the sleeves. In one embodiment, the plurality of receptacles is removably attached to the vehicle console using snaps or a hook-and-loop fastener, for example. In another embodiment, individual receptacles are removably attached to a spring-loaded ring binder, for example, that may in turn be removably attached to the vehicle console if desired.

The present invention provides a number of advantages. For example, the present invention provides an easily accessible system and method of stowing digital storage media within a vehicle console. Embodiments of the invention include a vehicle console with integrated media storage including optionally removable sleeves adapted to store flat media such as CD's, DVD's, and memory cards, such as those used to store digital pictures and music files, for example. The sleeve-style storage provides efficient space utilization allowing storage of more media than prior art systems, while the accordion-style or fan-out presentation of media facilitates storage and retrieval of selected media. The modular design may be incorporated into various types of vehicle consoles including overhead consoles, floor consoles, center seat consoles, etc.

The above advantage and other advantages and features of the present invention will be readily apparent from the following detailed description of the preferred embodiments when taken in connection with the accompanying drawings.

### BRIEF DESCRIPTION OF DRAWINGS

FIG. 1 is a perspective view of one embodiment of a vehicle console storage system or method of the present invention;

FIG. 2 is a cross-sectional view taken along line 2-2 of FIG. 1 with the storage compartment door in a closed position;

FIG. 3 is a cross-sectional view taken along line 2-2 of FIG. 1 with the storage compartment door in an open position;

FIG. 4 is a perspective view of a media storage system for a vehicle console according to the present invention;

FIG. 5 is a perspective view of an alternative embodiment of a media storage system for a vehicle console according to the present

FIG. 6 is a cross-sectional view of a lateral-opening media storage sleeve taken along line 6-6 of FIG. 5;

FIG. 7 is a perspective view of another alternative embodiment of a media storage system for a vehicle console according to the present invention; and

FIG. 8 is a cross-sectional view of a front-opening media storage sleeve taken along line 8-8 of FIG. 7.

### DETAILED DESCRIPTION

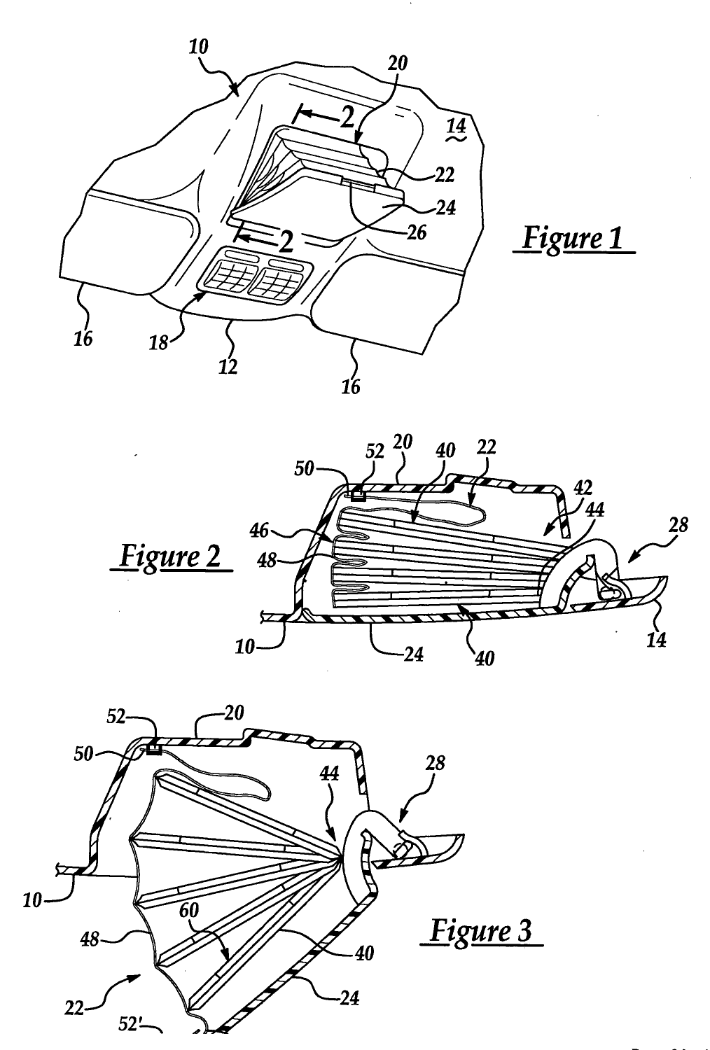

Referring now to FIG. 1, a perspective view of one embodiment of a vehicle console storage system or method according to the present invention is shown. As those of ordinary skill in the art will appreciate, various features of the present invention illustrated throughout the figures may be combined in ways other than those illustrated to provide a media storage system consistent with the teachings of the present invention. The combinations of features shown in the figures are representative only for ease of description and illustration.

In the embodiment of FIG. 1, vehicle console 10 is an overhead console centrally positioned toward a front edge 12 of the vehicle headliner 14. Visors 16 and convenience lights 18 are shown for reference. As will be appreciated by those of ordinary skill in the art, vehicle console 10 may be installed in a wide variety of vehicles that may include automobiles, trucks, buses, airplanes, watercraft, trains, and the like. Similarly, vehicle console 10 may be located anywhere within the vehicle for convenient access to media storage 22, i.e. a center console attached to the floor or a seat, or integrated into another interior portion of the vehicle, such as a door panel or dashboard, for example.

Console 10 includes a storage compartment 20 with a media storage system 22 according to the present invention adapted to store a wide variety of computer readable storage media including CDs, DVD's, floppy discs, and removable memory cards, such as those used in digital cameras and portable music players, for example. In this embodiment, storage compartment 20 includes a corresponding compartment door 24 having an associated latch 26 to secure door 24 in a closed position. Media storage system 22 preferably opens in an accordion style or fans out to present a plurality of receptacles having collapsible and expandable spacing therebetween to facilitate storage and retrieval of items upon opening of storage door 24. In one embodiment, the receptacles are implemented by a heat-sealed sleeve assembly that provides storage for twelve discs in an overhead compartment. As explained in greater detail below, media storage system 22 includes a connector joining the plurality of receptacles that limits the expandable spacing between adjacent receptacles. As such, the receptacles or sleeves are presented in spaced relation relative to one another to facilitate storage and retrieval of media. The use of a resilient or elastic connector would automatically retract the receptacles of storage system 22 for efficient storage within compartment 20 such that door 24 is not required for the present invention to operate as intended.

FIG. 2 is a cross-sectional view taken along line 2-2 of FIG. 1 with the storage compartment door in a closed position. Door 24 is pivotally connected to vehicle console 10 via a hinge assembly 28. Media storage system 22 includes a plurality of receptacles or sleeves 40 having their first ends 42 joined by a first connector 44 allowing pivotal movement about first connector 44. First connector 44 is permanently or removably attached to hinge assembly 28 for movement therewith. one embodiment, first connector 44 is removably fastened to hinge assembly 28 using snaps or a hook-and-loop fastener, for example. The second, opposing ends 46 of receptacles 40 are joined by at least one second flexible connector 48 that allows second ends 46 to fan-out, facilitating storage and retrieval of media upon opening of door 24, or other manual extension of receptacles 40 as described below. One or both ends of second connector 48 may include a flap or tab 50 adapted for securing media storage system 22 to storage compartment 20 using any of a number of fasteners 52, which may include permanent fasteners (screws, rivets, glue, etc.) or removable fasteners (snaps, twist locks, key and slot, hook-and-loop, etc.).

Referring now to FIG. 3, a cross-sectional view taken along line 2-2 FIG. 1 with the storage compartment door in an open position is shown. Receptacles 40 of media storage system 22 are shown in a partially extended or fanned out position. When fully extended, connector 48 allows the uppermost receptacle 40 to extend outside of vehicle console 10 to facilitate storage and retrieval of storage media. In this embodiment, connector 48 includes a first tab 50 for attachment of media storage system 22 to an interior portion of storage compartment 20 via a corresponding fastener 52, and a second tab 50″ for attachment of media storage system 22 to an interior surface of 24 via a corresponding fastener 52″. As also shown in FIG. 3, each receptacle 40 may allow storage of at least two media via laterally accessible openings 60 along each edge of receptacles 40 sufficient to accommodate disc-shaped media, such as a CD or DVD, for example.

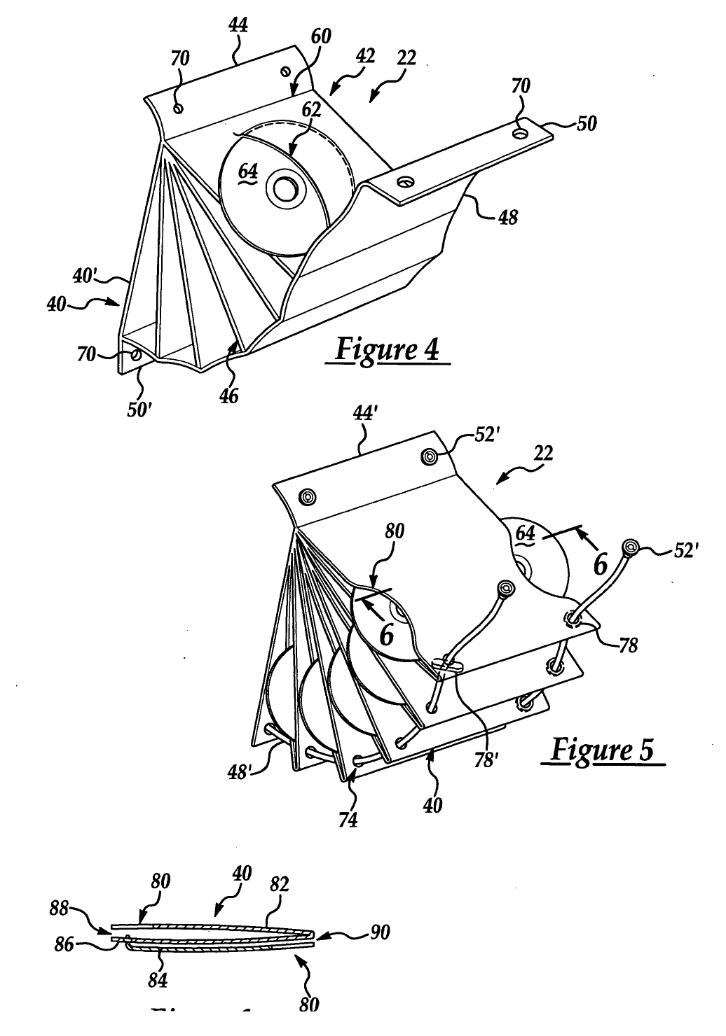

FIG. 4 is a perspective view of a media storage system for a vehicle console according to one embodiment of the present invention. In contrast to the embodiments illustrated in FIGS. 1-3 that include a first connector 44 having an extended pivot surface, in this embodiment the plurality of sleeves 40 has first ends 42 connected by first connector 44 along a common line 60 that provides pivotal movement of receptacles 40. Connector 44 extends as a tab or flap adapted for attachment to the vehicle console, such as via holes 70, for example. As will be appreciated by those of ordinary skill in the art, connector 44 may be implemented using a wide variety of devices to pivotally join receptacles 40. Depending upon the particular application, connector 44 may permanently join receptacles 40, or may allow for the addition or removal of individual receptacles. For example, connector 44 may be implemented using a spring loaded ring binder with one or more openable rings passing through corresponding apertures in receptacles 40. Alternatively, individual rings, loops, cords, or other binders may be used to permanently or removably join individual receptacles while allowing the accordion-style fan-out for storage and retrieval of media.

Each receptacle 40 of media storage system 22 includes an opening or slot 62 for receiving flat media. As will be appreciated by those of ordinary skill in the art, various types of receptacles or sleeves 40 may be used to secure the media. In the embodiment illustrated, slot 62 is an arcuate slot extending approximately midway across sleeve 40 and is sized to accommodate a corresponding disc shaped medium 64. As with the embodiments illustrated in FIGS. 1-3, receptacles 40 include laterally accessible slots 62. However, the particular implementation of receptacles 40 and/or orientation of slots or openings may vary depending upon the particular application and type of media being accommodated.

As also shown in FIG. 4, the second ends 46 of receptacles 40 are joined by a flexible connector 48 that extends across the front edge of each receptacle 40. Connector 48 also includes a tab or flap 50 having associated holes or apertures 70 to secure media storage system 22 to a vehicle console. An additional tab or flap 50″ may extend from the lowermost or outermost receptacle 40″ to be secured to a storage compartment door, for example. Alternatively, flap 50 may be used to grasp media storage system 22 to manually expand or fan out receptacles 40 to store or retrieve media.

FIG. 5 is a perspective view of an alternative embodiment of the media storage system for a vehicle console according to the present invention. Media storage system 22 includes a plurality of laterally opening sleeves 40 joined by a flexible connector 48″ that extends through corresponding apertures 74 of sleeves 40. Flexible connector 48″ may be implemented by a string, rope, cord, or the like with positive stops 78, 78″ provided to limit the extent of travel/pivoting (or stated differently to limit the expandable spacing between adjacent receptacles 40). For example, a small washer 78 or tab 78″ may be secured to flexible connector 48″ to provide a maximum desired spacing between receptacles 40.

In one embodiment, connector 48″ is implemented by one or more resilient or elastic cords to join receptacles 40. In this embodiment, the expandable spacing to provide the accordion-style presentation of stowed media is provided by the user stretching the flexible connector 48″. When released, the flexible connector 48″ retracts or collapses receptacles containing any stowed media for efficient use of the associated vehicle storage compartment.

Flexible connectors 44″ and 48″ include fasteners 52″, such as snaps, to removably secure media storage system 22 within a vehicle console. Of course, any number or type of removable or permanent fasteners could also be used to secure media storage system 22 within an associated vehicle console. However, the use of fasteners that allow selective removal of media storage system 22 from a corresponding vehicle console may provide a number of additional advantages relative to a permanent installation. For example, a removable storage system has the advantages of portable media storage in addition to being secured within the vehicle during transit. In addition, a removable storage system provides flexibility in configuration of a vehicle interior. Multiple storage compartments/consoles could be equipped with fasteners adapted to receive a media storage system according to the present invention so individual consumers could securely store their media in one or more of the available locations. Likewise, a media storage system according to the present invention could be easily transported between consoles of similarly equipped vehicles.

FIG. 6 is a cross-sectional view of a lateral-opening media storage sleeve taken along line 6-6 of FIG. 5 of one embodiment of the present invention. As shown in FIGS. 5 and 6, each receptacle 40 may include an arcuate recess 80 to facilitate grasping of media during storage and retrieval. As also illustrated, each receptacle 40 preferably accommodates at least two disc shaped media. Sleeve 40 may include a top surface 82 and a bottom surface 84 with a separator 86 in the middle. A first lateral opening 88 is formed between top surface 82 and separator 86 along the left side as illustrated in FIG. 6. A second lateral opening 90 is formed between bottom surface 84 and separator 86 along the right side as illustrated in FIG. 6. This configuration accommodates two disc shaped media with separator 86 reducing or eliminating contact between the media. The lateral opening receptacles 40 are particularly suited for use in an overhead console as they provide easy access to the user while reducing the possibility of the media falling out of the receptacles upon opening of the console and/or expansion of the media storage system.

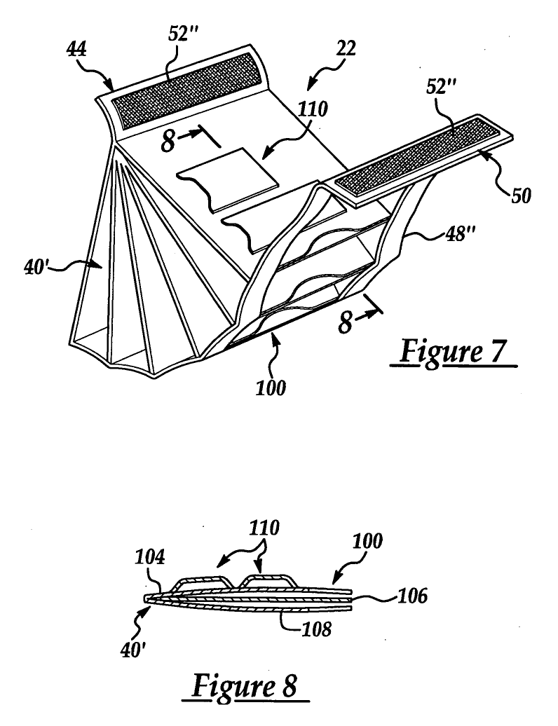

FIG. 7 is a perspective view of another embodiment of a media storage system for a vehicle console according to the present invention. Media storage system 22 includes a plurality of plastic sleeves 40″ joined at one end by a first connector 44 and at the other end by at least one second connector 48″. In this embodiment, second connector 48″ is a flexible band, ribbon, or the like that connects sleeves 40″ and extends to a flap or tab 50 adapted for fastening to a vehicle console. A fastener 52″, such as a hook-and-loop type fastener (one brand of which is VELCRO™), provides for selective removal of the media storage system 22 from the vehicle console. Similarly, first connector 44 includes a hook-and-loop type fastener 52″to removably fasten media storage system 22 to a vehicle console.

As also shown in FIG. 7, sleeves 40″ may be configured to provide front end openings 100 adapted to store disc shaped media. Of course, sleeves 40″ should provide sufficient tension to secure stowed media when expanded. At least one of the plurality of sleeves 40″ may include additional rectangular pockets 110 with arcuate openings to accommodate storage of memory cards, such as those used in digital cameras and personal audio players, for example.

FIG. 8 is a cross-sectional view of a front opening media storage sleeve taken along line 8-8 of FIG. 7. Sleeve 40″ includes a top surface 104 with an arcuate front opening 100, a separator 106, and a bottom surface 108 with an arcuate front opening. Sleeve 40″ accommodates a first disc-shaped medium between top surface 104 and separator 106 and a second disc-shaped medium between bottom surface 108 and separator 106. The arcuate openings facilitate grasping of a desired disc.

As those of ordinary skill in the art will appreciate, the present invention provides an easily accessible system and method of stowing digital storage media within a vehicle console. The media storage system can be easily incorporated within a vehicle console and may provide optionally removable sleeves adapted to store flat media such as CD's, DVD's, and memory cards, for example. The sleeve-style storage provides efficient space utilization, while the accordion-style or fan-out presentation of media facilitates easy and convenient storage and retrieval of selected media. The modular design may be incorporated into various types of vehicle consoles including overhead consoles (fixed or modular/configurable), floor consoles, center seat consoles, etc.

While the best mode for carrying out the invention has been described in detail, those familiar with the art to which this invention relates will recognize various alternative designs and embodiments for practicing the invention as defined by the following claims.

1. A method for providing storage within a vehicle console having a compartment with a storage door, the method comprising:
presenting a plurality of receptacles having collapsible and expandable spacing therebetween to facilitate storage and retrieval of items upon opening of the storage door.

2. The method of claim 1 wherein the plurality of receptacles are joined by a flexible material to limit the expandable spacing.

3. The method of claim 2 further comprising:
attaching the flexible material to an interior portion of the console.

4. The method of claim 3 wherein the step of attaching comprises removably attaching the flexible material.

5. The method of claim 4 wherein the step of attaching comprises attaching the flexible material using snaps.

6. The method of claim 4 wherein the step of attaching comprises attaching the flexible material with a hook-and-loop type fastener.

7. The method of claim 3 wherein the step of attaching comprises fixedly attaching the flexible material.

8. The method of claim 2 further comprising:
attaching a first portion of the flexible material to the console and a second portion of the flexible material to the storage door.

9. The method of claim 1 wherein at least one of the plurality of receptacles is adapted to receive a flat digital storage medium.

10. The method of claim 9 wherein the flat digital storage medium comprises a CD.

11. The method of claim 9 wherein the flat digital storage medium comprises a DVD.

12. The method of claim 1 wherein the vehicle console comprises an overhead console.

13. The method of claim 1 wherein the vehicle console comprises a floor console.

14. The method of claim 1 wherein at least one of the plurality of receptacles is adapted to laterally receive the items for storage.

15. A console for a vehicle, the console comprising:
a media storage compartment having a plurality of receptacles arranged to selectively fan-out to facilitate access to the receptacles for storage and retrieval of items.

16. The console of claim 15 further comprising:
a media storage compartment door, wherein the plurality of receptacles is arranged to selectively fan-out upon opening of the media storage compartment door.

17. The console of claim 15 wherein the plurality of receptacles is adapted for storing flat media.

18. The console of claim 17 wherein at least one of the plurality of receptacles is adapted for storing a CD.

19. The console of claim 17 wherein at least one of the plurality of receptacles is adapted for storing a memory card.

20. The console of claim 15 wherein each of the plurality of receptacles comprises a plastic sleeve.

21. The console of claim 15 wherein the plurality of receptacles is joined by a flexible material to limit spacing between adjacent receptacles.

22. The console of claim 21 wherein the flexible material comprises a cord.

23. The console of claim 21 wherein the flexible material comprises a band.

24. The console of claim 15 wherein the plurality of receptacles is removably fastened to the media storage compartment.

25. The console of claim 24 wherein the plurality of receptacles is removably fastened to the media storage compartment with at least one snap.

26. The console of claim 24 wherein the plurality of receptacles is removably fastened to the media storage compartment with a hook-and-loop fastener.

27. The console of claim 15 wherein each of the plurality of receptacles opens laterally to receive media for storage.

28. The console of claim 15 wherein each of the receptacles comprises a dual plastic sleeve having a center separator disposed between top and bottom plastic sheets to accommodate two media without contact therebetween.

29. A media storage system for use in a vehicle console, the media storage system comprising:
a plurality of sleeves having first ends connected by a first connector allowing pivotal movement about the first connector and second opposing ends joined by at least one second connector allowing the second ends to fan-out to facilitate storage and retrieval of media, each of the sleeves being adapted to stow at least one storage medium, wherein the first and second connectors are adapted for fastening to the vehicle console.

30. The media storage system of claim 29 wherein the first and second connectors are adapted for removably fastening the plurality of sleeves to the vehicle console.

31. The media storage system of claim 30 wherein the first and second connectors include hook-and-loop fasteners.

32. The media storage system of claim 29 wherein the first and second connectors are fixedly secured to an interior portion of the vehicle console.

33. The media storage system of claim 29 wherein each of the plurality of sleeves includes a lateral opening extending a sufficient distance between the first and second ends to accommodate disc-shaped media.

34. The media storage system of claim 33 wherein the second connector comprises a flexible connector extending along the second ends of the plurality of sleeves.

35. The media storage system of claim 33 wherein the second connector extends through the second ends of the plurality of sleeves.
